(19) United States
(12) Patent Application Publication
(10) Pub. No.: US 2020/0307625 A1
(43) Pub. Date: Oct. 1, 2020

(54) AUTOMATED DRIVING SYSTEM

(71) Applicant: Toyota Jidosha Kabushiki Kaisha, Toyota-shi Aichi-ken (JP)

(72) Inventors: Go Inoue, Gotemba-shi (JP); Yoshinori Watanabe, Isehara-shi (JP); Hirotaka Tokoro, Inazawa-shi (JP)

(21) Appl. No.: 16/829,424

(22) Filed: Mar. 25, 2020

(30) Foreign Application Priority Data
Mar. 27, 2019 (JP) 2019-061643

(51) Int. Cl. B60W 60/00; B62D 5/04; B60W 10/184; B60W 10/04; B60W 10/20; G05D 1/00

(52) U.S. Cl. CPC B60W 60/001; B62D 5/0457; B60W 10/184; G05D 2201/0213; B60W 10/20; G05D 1/0088; G05D 2201/0212; B60W 10/04

(57) ABSTRACT

A vehicle has first and second wheels arranged in a longitudinal direction. In vehicle travel control, a control device calculates a control amount based on a parameter detected by a sensor and controls vehicle travel in accordance with the control amount. Modes of the vehicle travel control include first and second modes. In the first mode, a forward direction is from the second wheel toward the first wheel. In the second mode, the forward direction is from the first wheel toward the second wheel. The control device holds definition information that defines at least one of the detected parameter and the control amount. In the first mode, the control device executes the vehicle travel control in accordance with first definition information for the first mode. In the second mode, the control device executes the vehicle travel control in accordance with second definition information for the second mode.

### CROSS-REFERENCE TO RELATED APPLICATIONS

This application claims priority to Japanese Patent Application No. 2019-061643 filed on Mar. 27, 2019, which is incorporated herein by reference in its entirety including the specification, drawings and abstract.

### BACKGROUND

### Technical Field

The present disclosure relates to an automated driving system that controls automated driving of a vehicle.

### Background Art

Patent Literature 1 discloses a technique that controls automated driving of a vehicle. A control unit automatically controls steering, acceleration, and deceleration of the vehicle based on information detected by a sensor.

### SUMMARY

Automated driving control that controls automated driving of a vehicle is considered. The automated driving control includes vehicle travel control that controls travel (i.e., steering, acceleration, and deceleration) of the vehicle. In a case of a general vehicle, a front wheel and a rear wheel, that is, a forward direction and a backward direction are predefined (fixed).

An object of the present disclosure is to provide a technique that can flexibly switch a forward direction and a backward direction in the automated driving control that controls automated driving of a vehicle.

A first aspect is directed to an automated driving system that controls automated driving of a vehicle.

The vehicle has a first wheel and a second wheel that are arranged separately in a longitudinal direction.

A first direction is a direction from the second wheel toward the first wheel. A second direction is a direction from the first wheel toward the second wheel. The automated driving system includes:

a sensor configured to detect a parameter representing a travel state of the vehicle;

a travel device configured to perform steering, acceleration, and deceleration of the vehicle; and

a control device configured to execute vehicle travel control that calculates a control amount based on an input value associated with a detected value of the parameter and controls the travel device in accordance with the control amount.

Definition information defines a correspondence relationship between the detected value and the input value.

Modes of the vehicle travel control include:

a first mode in which the vehicle travel control is executed by setting the first direction as a forward direction; and

a second mode in which the vehicle travel control is executed by setting the second direction as the forward direction.

The control device is further configured to:

hold first definition information being the definition information for the first mode and second definition information being the definition information for the second mode;

execute the vehicle travel control in accordance with the first definition information in the first mode; and

execute the vehicle travel control in accordance with the second definition information in the second mode.

A second aspect is directed to an automated driving system that controls automated driving of a vehicle.

The vehicle has a first wheel and a second wheel that are arranged separately in a longitudinal direction.

A first direction is a direction from the second wheel toward the first wheel. A second direction is a direction from the first wheel toward the second wheel. The automated driving system includes:

a sensor configured to detect a parameter representing a travel state of the vehicle;

a travel device configured to perform steering, acceleration, and deceleration of the vehicle; and

a control device configured to execute vehicle travel control that calculates a control amount based on the parameter and controls the travel device in accordance with an instruction control amount associated with the calculated control amount.

Definition information defines a correspondence relationship between the calculated control amount and the instruction control amount.

Modes of the vehicle travel control include:

a first mode in which the vehicle travel control is executed by setting the first direction as a forward direction; and

a second mode in which the vehicle travel control is executed by setting the second direction as the forward direction.

The control device is further configured to:

hold first definition information being the definition information for the first mode and second definition information being the definition information for the second mode;

execute the vehicle travel control in accordance with the first definition information in the first mode; and

execute the vehicle travel control in accordance with the second definition information in the second mode.

The control device of the automated driving system executes the vehicle travel control. In the vehicle travel control, the control device calculates the control amount based on the parameter detected by the sensor and controls the travel device in accordance with the control amount.

Modes of the vehicle travel control include the first mode and the second mode. In the first mode, the control device executes the vehicle travel control by setting the first direction from the second wheel toward the first wheel as the forward direction. In the second mode, on the other hand, the control device executes the vehicle travel control by setting the second direction from the first wheel toward the second wheel as the forward direction. That is, according to the present disclosure, the forward direction and the backward direction are not fixed but flexibly switchable.

In order to appropriately execute the vehicle travel control, it is necessary to switch a definition of the detected parameter or the control amount along with the switching of the mode (i.e., the switching of the forward direction and the backward direction). The definition of the detected parameter is the correspondence relationship between the detected value detected by the sensor and the input value used for calculating the control amount. The definition of the control amount is the correspondence relationship between the control amount calculated by the control device and the instruction control amount for the travel device.

The control device holds the definition information that defines at least one of the detected parameter and the control amount. The definition information includes the first definition information for the first mode and the second definition information for the second mode. In the first mode, the control device executes the vehicle travel control in accordance with the first definition information. In the second mode, on the other hand, the control device executes the vehicle travel control in accordance with the second definition information. As a result, it is possible to flexibly switch the forward direction and the backward direction and to appropriately execute the vehicle travel control.

### BRIEF DESCRIPTION OF DRAWINGS

FIG. 1 is a conceptual diagram for explaining an automated driving system according to a first embodiment of the present disclosure;

FIG. 2 is a block diagram showing a configuration example of the automated driving system according to the first embodiment of the present disclosure;

FIG. 3 is a conceptual diagram for explaining vehicle travel control according to the first embodiment of the present disclosure;

FIG. 4 is a conceptual diagram for explaining an example of the vehicle travel control according to the first embodiment of the present disclosure;

FIG. 5 is a conceptual diagram for explaining an example of switching of a definition in the first embodiment of the present disclosure;

FIG. 6 is a conceptual diagram for explaining another example of switching of a definition in the first embodiment of the present disclosure;

FIG. 7 is a conceptual diagram for explaining yet another example of switching of a definition in the first embodiment of the present disclosure;

FIG. 8 is a block diagram showing a functional configuration example of a control device of the automated driving system according to the first embodiment of the present disclosure;

FIG. 9 is a timing chart for explaining state maintenance control according to a third embodiment of the present disclosure; and

FIG. 10 is a block diagram showing a functional configuration example of the control device of the automated driving system according to a third embodiment of the present disclosure.

### DETAILED DESCRIPTION OF EMBODIMENTS

Embodiments of the present disclosure will be described below with reference to the attached drawings.

### 1. First Embodiment

1-1. Schematic Configuration of Automated Driving System

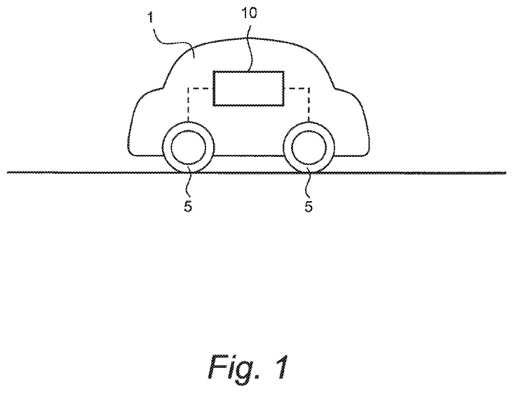

FIG. 1 is a conceptual diagram for explaining an automated driving system 10 according to the present embodiment. The automated driving system 10 executes automated driving control that controls automated driving of a vehicle 1. The automated driving control includes vehicle travel control that controls travel (i.e., steering, acceleration, and deceleration) of the vehicle 1. Typically, the automated driving system 10 is installed on the vehicle 1.

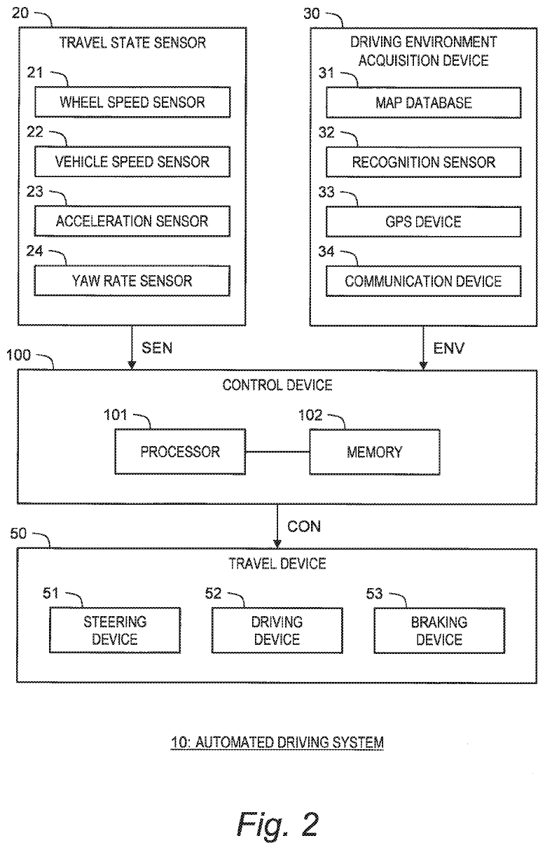

FIG. 2 is a block diagram showing a configuration example of the automated driving system 10 according to the present embodiment. The automated driving system 10 includes a travel state sensor 20, a driving environment acquisition device 30, a travel device 50, and a control device (controller) 100.

The travel state sensor 20 detects a parameter representing a travel state of the vehicle 1. For example, the travel state sensor 20 includes a wheel speed sensor 21, a vehicle speed sensor 22, an acceleration sensor 23, a yaw rate sensor 24, and the like. The wheel speed sensor 21 detects a rotating speed of each wheel 5 of the vehicle 1. The vehicle speed sensor 22 detects a vehicle speed being a speed of the vehicle 1. The acceleration sensor 23 detects accelerations (e.g., a lateral acceleration, a longitudinal acceleration, and a vertical acceleration) of the vehicle 1. The yaw rate sensor 24 detects a yaw rate of the vehicle 1. The travel state sensor 20 sends a detected parameter SEN to the control device 100.

The driving environment acquisition device 30 acquires driving environment information ENV indicating driving environment for the vehicle 1. For example, the driving environment acquisition device 30 includes a map database 31, a recognition sensor 32, a GPS (Global Positioning System) device 33, a communication device 34, and so forth.

The map database 31 is a database of map information indicating a lane configuration and a road shape. The driving environment acquisition device 30 acquires the map information of a required area from the map database 31. The map database 31 may be stored in a predetermined memory device mounted on the vehicle 1, or may be stored in a management server outside the vehicle 1. In the latter case, the driving environment acquisition device 30 communicates with the management server through the communication device 34 to acquire the necessary map information from the map database 31 of the management server.

The recognition sensor 32 recognizes (detects) a situation around the vehicle 1. For example, the recognition sensor 32 includes a camera, a LIDAR (Laser Imaging Detection and Ranging), and a radar. Surrounding situation information indicates a result of recognition (perception) by the recognition sensor 32. For example, the surrounding situation information includes information on a surrounding vehicle and a white line around the vehicle 1.

The GPS device 33 acquires position information that indicates a position and an orientation of the vehicle 1. Matching a configuration of the white line detected by the recognition sensor 32 and the lane configuration indicated by the map information makes it possible to acquire further accurate position information. As another example, the position information may be acquired through V2X communication (i.e., vehicle-to-vehicle communication and vehicle-to-infrastructure communication) using the communication device 34.

The driving environment information ENV includes the map information, the surrounding situation information, and the position information described above. The driving environment acquisition device 30 sends the acquired driving environment information ENV to the control device 100.

The travel device 50 performs steering (i.e., turning of the wheel 5), acceleration, and deceleration of the vehicle 1. More specifically, the travel device 50 includes a steering device 51, a driving device 52, and a braking device 53. The steering device 51 turns (i.e., changes a direction of) the wheel 5. For example, the steering device 51 includes a power steering (EPS: Electric Power Steering) device. The driving device 52 is a power source that generates a driving force of the wheel 5. The driving device 52 is exemplified by an engine and an electric motor. The braking device 53 generates a braking force of the wheel 5. An operation of the travel device 50 is controlled by the control device 100.

The control device (controller) 100 includes a microcomputer including a processor 101 and a memory 102. The control device 100 is also called an ECU (Electronic Control Unit). A variety of processing by the control device 100 is achieved by the processor 101 executing a control program stored in the memory 102.

For example, the control device 100 executes the vehicle travel control that controls travel of the vehicle 1 by controlling the travel device 50. More specifically, the control device 100 calculates a control amount CON for the vehicle travel control based on the detected parameter SEN and the driving environment information ENV. The control device 100 controls the travel device 50 in accordance with the control amount CON to execute the vehicle travel control. The vehicle travel control includes steering control that controls the steering (i.e., the turning of the wheel 5) and acceleration/deceleration control that controls the acceleration/deceleration. The control device 100 executes the steering control by controlling the steering device 51. Moreover, the control device 100 executes the acceleration/deceleration control by controlling the driving device 52 and the braking device 53.

Furthermore, the control device 100 uses the above-described vehicle travel control to execute the automated driving control that controls automated driving of the vehicle 1. For example, the control device 100 periodically generates a target trajectory based on the driving environment information ENV. For example, the target trajectory includes a line along a center of a travel lane. The control device 100 can calculate the target trajectory based on the map information and the position information. As another example, the control device 100 can calculate the target trajectory based on the surrounding situation information (specifically, the information on the white line). However, the target trajectory and a method of calculating thereof are not limited to those. The control device 100 generates the target trajectory and then executes the vehicle travel control such that the vehicle 1 follows the target trajectory.

Hereinafter, the vehicle travel control according to the present embodiment will be described in more details.

1-2. Vehicle Travel Control

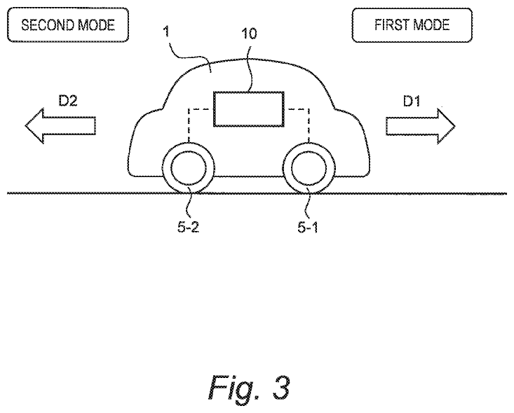

FIG. 3 is a conceptual diagram for explaining the vehicle travel control according to the present embodiment. The vehicle 1 has a first wheel 5-1 and a second wheel 5-2 that are arranged separately in a longitudinal direction. The longitudinal direction is a planar direction orthogonal to a lateral direction of the vehicle 1. In the following description, a first direction D1 is a direction from the second wheel 5-2 toward the first wheel 5-1. On the other hand, a second direction D2 is a direction from the first wheel 5-1 to the second wheel 5-2.

The vehicle 1 according to the present embodiment is configured to be able to achieve a similar vehicle behavior for each of the first direction D1 and the second direction D2. More specifically, the steering device 51 is configured to be able to turn the first wheel 5-1 and the second wheel 5-2 independently. The driving device 52 is configured to be able to generate the driving force in each of the first direction D1 and the second direction D2. A drive wheel may be one of the first wheel 5-1 and the second wheel 5-2, or may be both of the first wheel 5-1 and the second wheel 5-2. The braking device 53 is configured to be able to generate the braking force in each of the first direction D1 and the second direction D2.

In a case of a general vehicle, a front wheel and a rear wheel, that is, a forward direction and a backward direction are predefined (fixed). For example, the first wheel 5-1 is always the front wheel, the second wheel 5-2 is always the rear wheel, the first direction D1 is always the forward direction, and the second direction D2 is always the backward direction.

According to the present embodiment, on the other hand, the front wheel and the rear wheel, that is, the forward direction and the backward direction are not predefined (fixed) but flexibly switchable. For that purpose, modes of the vehicle travel control include two types, a “first mode” and a “second mode”.

In the first mode, the first direction D1 is the forward direction and the second direction D2 is the backward direction. The control device 100 executes the vehicle travel control by setting the first direction D1 as the forward direction. Therefore, in the first mode, the first wheel 5-1 serves as the front wheel and the second wheel 5-2 serves as the rear wheel.

In the second mode, the second direction D2 is the forward direction and the first direction D1 is the backward direction. The control device 100 executes the vehicle travel control by setting the second direction D2 as the forward direction. Therefore, in the second mode, the second wheel 5-2 serves as the front wheel and the first wheel 5-1 serves as the rear wheel.

For example, the control device 100 determines a desired movement direction as the forward direction based on the driving environment information ENV. When the determined forward direction is the first direction D1, the control device 100 executes the vehicle travel control in the first mode. On the other hand, when the determined forward direction is the second direction D2, the control device 100 executes the vehicle travel control in the second mode. The control device 100 executes switching processing that switches the mode of the vehicle travel control between the first mode and the second mode, as necessary.

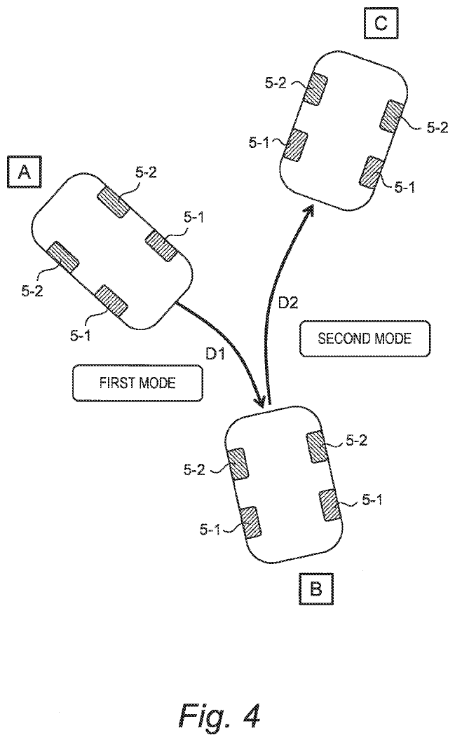

As an example, let us consider a situation as shown in FIG. 4. When moving from a point A to a point B, the control device 100 executes the vehicle travel control in the first mode to make the vehicle 1 move forward in the first direction D1. At the point B, the control device 100 switches the mode of the vehicle travel control from the first mode to the second mode. When moving from the point B to a point C, the control device 100 executes the vehicle travel control in the second mode to make the vehicle 1 move forward in the second direction D2. In this manner, the control device 100 can execute the vehicle travel control such that the vehicle 1 always moves forward in the forward direction without moving backward.

As a comparative example, let us consider a case where the first wheel 5-1 is fixed as the front wheel and the second wheel 5-2 is fixed as the rear wheel. In the section from the point A to the point B, forward movement control is executed such that the vehicle 1 moves forward in the forward direction. In the section from the point B to the point C, backward movement control may be executed such that the vehicle 1 moves backward in the backward direction. However, continuing the backward movement control over a long time is not realistic. Moreover, continuing the backward movement control over a long time causes an occupant of the vehicle 1 feel a sense of strangeness. It is necessary to turn around the vehicle 1 in order to execute the forward movement control also in the section from the point B to the point C. In that case, however, a travel time required for the vehicle 1 to move from the point B to the point C is increased, and thus a travel efficiency is decreased.

According to the present embodiment, on the other hand, it is not necessary to turn around the vehicle 1 when moving from the point B to the point C, as shown in FIG. 4. Flexibly switching the forward direction (i.e., the mode) makes it possible to efficiently move the vehicle 1.

1-3. Switching of Definition

As described above, in the vehicle travel control, the control device 100 calculates the control amount CON based on the detected parameter SEN and controls the travel device 50 in accordance with the control amount CON. It may be necessary to switch a “definition” of the detected parameter SEN or the control amount CON as well along with the switching of the mode of the vehicle travel control (i.e., the switching of the forward direction and the backward direction).

As an example, let us consider the wheel speed sensor 21. The wheel speed sensor 21 in this example detects a rotating speed and a direction of rotation of each wheel 5. For example, a sign of a detected value of the rotating speed is “positive” when the vehicle 1 moves in the first direction D1, and the sign of the detected value of the rotating speed is “negative” when the vehicle 1 moves in the second direction D2. When the sign is “positive”, the control device 100 judges that the vehicle 1 is moving forward. When the sign is “negative”, the control device 100 judges that the vehicle 1 is moving backward.

When the vehicle 1 moves from the point B to the point C in FIG. 4 described above, the sign of the detected value of the rotating speed is “negative”. If the negative detected value is used as it is, the control device 100 erroneously judges that the vehicle 1 is moving backward. In that case, the control device 100 executes unnecessary braking control and the vehicle 1 stops moving. In order to prevent such the misjudgment and the erroneous control, it is necessary to appropriately modify the sign. That is to say, it is necessary to appropriately switch a “definition” of the detected parameter SEN.

As another example, let us consider the steering control that controls turning of the wheel 5. The control device 100 in this example simply calculates a target steering amount of a front wheel as the control amount CON without distinguishing between the first wheel 5-1 and the second wheel 5-2. However, since the actual front wheel varies depending on the mode, it is necessary to appropriately switch a target to which the calculated control amount CON is applied. More specifically, in the first mode, it is necessary to control the first wheel 5-1 in accordance with the control amount CON. In the second mode, it is necessary to control the second wheel 5-2 in accordance with the control amount CON. That is to say, it is necessary to appropriately switch a “definition” of the control amount CON.

For the purpose of convenience, the detected parameter SEN detected by the travel state sensor 20 is hereinafter referred to as a “detected value SEN-A.” The detected parameter SEN used for calculating the control amount CON is hereinafter referred to as an “input value SEN-B.” The control amount CON calculated by the control device 100 is hereinafter referred to as a “calculated control amount CON-A.” The control amount CON used for controlling the travel device 50 is hereinafter referred to as an “instruction control amount CON-B.”

The detected value SEN-A and the input value SEN-B are associated with each other. A correspondence relationship between the detected value SEN-A and the input value SEN-B is equivalent to the “definition” of the detected parameter SEN. Moreover, the calculated control amount CON-A and the instruction control amount CON-B are associated with each other. A correspondence relationship between the calculated control amount CON-A and the instruction control amount CON-B is equivalent to the “definition” of the control amount CON.

1-3-1. Switching of definition of detected parameter

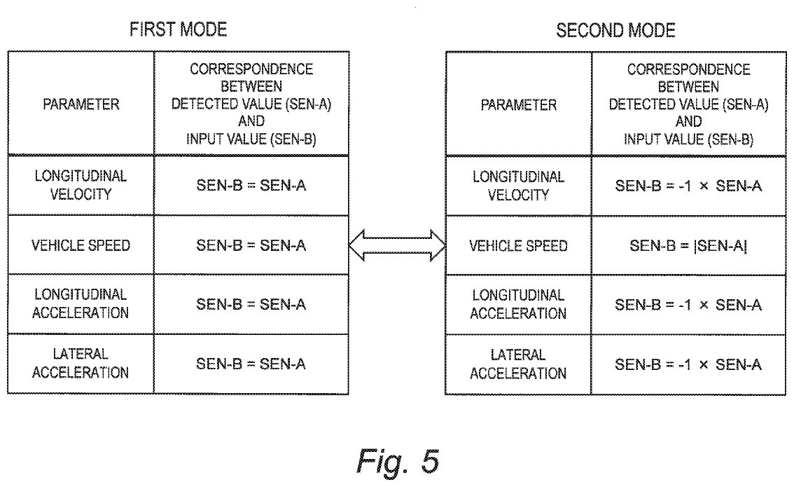

FIG. 5 shows an example of switching of the definition of the detected parameter SEN.

As an example, let us consider a longitudinal velocity detected by the wheel speed sensor 21 or the vehicle speed sensor 22. A sign of the detected value SEN-A of the longitudinal velocity varies depending on whether a movement direction of the vehicle 1 is the first direction D1 or the second direction D2. In the first mode, the input value SEN-B of the longitudinal velocity is the detected value SEN-A. In the second mode, on the other hand, the input value SEN-B of the longitudinal velocity is −1 times (i.e., negative one times) the detected value SEN-A. In other words, in the second mode, the input value SEN-B is opposite in the sign to the detected value SEN-A. As described, the definition of the longitudinal velocity is different between in the first mode and in the second mode and is switched according to the mode.

It is also possible to reverse the definition content for the first mode and the definition content for the second mode. This also applies to the following description. In either case, different definitions are used in the first mode and in the second mode.

As another example, let us consider the vehicle travel control designed on the assumption that the vehicle speed is a positive value. The vehicle speed is detected by the wheel speed sensor 21 or the vehicle speed sensor 22. A sign of the detected value SEN-A of the vehicle speed varies depending on whether the movement direction of the vehicle 1 is the first direction D1 or the second direction D2. For example, the sign of the detected value SEN-A of the vehicle speed is positive when the vehicle 1 moves in the first direction D1, and the sign of the detected value SEN-A of the vehicle speed is negative when the vehicle 1 moves in the second direction D2. In the first mode, the input value SEN-B of the vehicle speed is the detected value SEN-A. In the second mode, the input value SEN-B of the vehicle speed is an absolute value of the detected value SEN-A. As described, the definition of the vehicle speed is different between in the first mode and in the second mode and is switched according to the mode.

As yet another example, let us consider the acceleration (e.g., the longitudinal acceleration, the lateral acceleration) detected by the acceleration sensor 23. A sign of the detected value SEN-A of the acceleration varies depending on whether an acceleration direction of the vehicle 1 is a third direction or a fourth direction. In the case of the longitudinal acceleration, the third direction is the first direction D1 and the fourth direction is the second direction D2. In the case of the lateral acceleration, the third direction is a lateral direction orthogonal to the first direction D1 and the second direction D2, and the fourth direction is another lateral direction opposite to the third direction. In the first mode, the input value SEN-B of the acceleration is the detected value SEN-A. In the second mode, on the other hand, the input value SEN-B of the acceleration is −1 times (i.e., negative one times) the detected value SEN-A. In other words, in the second mode, the input value SEN-B is opposite in the sign to the detected value SEN-A. As described, the definition of the acceleration is different between in the first mode and in the second mode and is switched according to the mode.

1-3-2. Switching of definition related to steering control

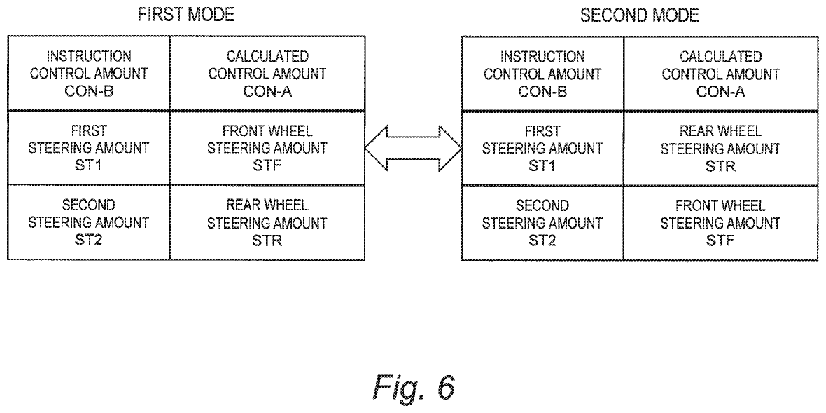

FIG. 6 shows an example of switching of the definition related to the steering control. The control device 100 calculates the calculated control amount CON-A related to the steering control. The calculated control amount CON-A includes a front wheel steering amount STF being a target steering amount of the front wheel and a rear wheel steering amount STR being a target steering amount of the rear wheel. The control device 100 refers to the forward direction to calculate the front wheel steering amount STF and the rear wheel steering amount STR as the calculated control amount CON-A.

The instruction control amount CON-B used for controlling the steering device 51 includes a first steering amount ST1 being a target steering amount of the first wheel 5-1 and a second steering amount ST2 being a target steering amount of the second wheel 5-2. In the first mode, the first steering amount ST1 is the front wheel steering amount STF and the second steering amount ST2 is the rear wheel steering amount STR. In the second mode, on the other hand, the first steering amount ST1 is the rear wheel steering amount STR and the second steering amount ST2 is the front wheel steering amount STF. As described, the definition of the control amount CON is different between in the first mode and in the second mode and is switched according to the mode.

It should be noted here that computation processing itself for calculating the control amount CON is the same in the first mode and in the second mode. Regardless of the mode, the control device 100 just calculates the required front wheel steering amount STF and rear wheel steering amount STR. Since the definition of the control amount CON is switched according to the mode, it is not necessary to switch the computation processing itself for calculating the control amount CON according to the mode. There is no need to separately prepare the computation processing for the first mode and the computation processing for the second mode, and thus the computation processing is simplified. This contributes to reduction in computation load and computation time.

1-3-3. Switching of definition related to acceleration/deceleration control

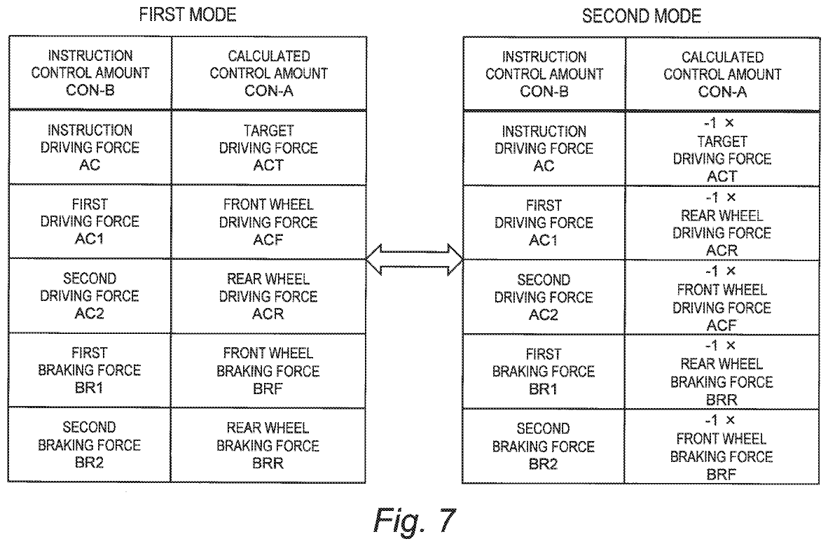

FIG. 7 shows an example of switching of the definition related to the acceleration/deceleration control.

As an example, let us consider the control amount CON for controlling the driving device 52. First, let us consider a case where one of the first wheel 5-1 and the second wheel 5-2 is the drive wheel. The calculated control amount CON-A includes a target driving force ACT. The control device 100 calculates the target driving force ACT required for moving the vehicle 1 forward. The instruction control amount CON-B used for controlling the driving device 52 includes an instruction driving force AC of the drive wheel. In the first mode, the instruction driving force AC is the target driving force ACT. In the second mode, on the other hand, the instruction driving force AC is −1 times (i.e., negative one times) the target driving force ACT. In other words, in the second mode, the instruction control amount CON-B is opposite in the sign to the calculated control amount CON-A.

Next, let us consider a case where both of the first wheel 5-1 and the second wheel 5-2 are the drive wheels. The calculated control amount CON-A includes a front wheel driving force ACF being a target driving force of the front wheel and a rear wheel driving force ACR being a target driving force of the rear wheel. The control device 100 refers to the forward direction to calculate the front wheel driving force ACF and the rear wheel driving force ACR as the calculated control amount CON-A. The instruction control amount CON-B used for controlling the driving device 52 includes a first driving force AC1 being a target driving force of the first wheel 5-1 and a second driving force AC2 being a target driving force of the second wheel 5-2. In the first mode, the first driving force AC1 is the front wheel driving force ACF and the second driving force AC2 is the rear wheel driving force ACR. In the second mode, on the other hand, the first driving force AC1 is −1 times the rear wheel driving force ACR and the second driving force AC2 is −1 times the front wheel driving force ACF.

As another example, let us consider the control amount CON for controlling the braking device 53. The calculated control amount CON-A includes a front wheel braking force BRF being a target braking force of the front wheel and a rear wheel braking force BRR being a target braking force of the rear wheel. The control device 100 refers to the forward direction to calculate the front wheel braking force BRF and the rear wheel braking force BRR as the calculated control amount CON-A. The instruction control amount CON-B used for controlling the braking device 53 includes a first braking force BR1 being a target braking force of the first wheel 5-1 and a second braking force BR2 being a target braking force of the second wheel 5-2. In the first mode, the first braking force BR1 is the front wheel braking force BRF and the second braking force BR2 is the rear wheel braking force BRR. In the second mode, on the other hand, the first braking force BR1 is −1 times the rear wheel braking force BRR and the second braking force BR2 is −1 times the front wheel braking force BRF.

The same applies to a case where an instruction amount for an actuator such as a caliper of the braking device 53 has a positive or negative sign.

As described above, the definition of the control amount CON is different between in the first mode and in the second mode and is switched according to the mode. Since the definition of the control amount CON is switched according to the mode, it is not necessary to switch the computation processing itself for calculating the control amount CON according to the mode. There is no need to separately prepare the computation processing for the first mode and the computation processing for the second mode, and thus the computation processing is simplified. This contributes to reduction in computation load and computation time.

I-4. Processing By Control Device

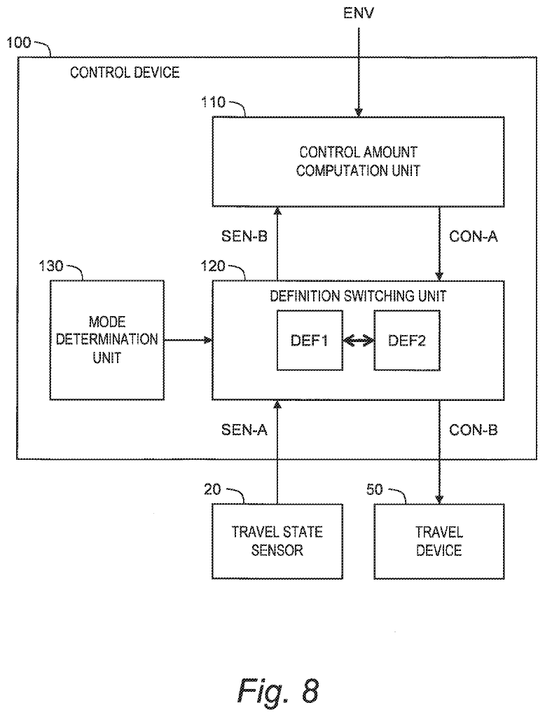

FIG. 8 is a block diagram showing a functional configuration example of the control device 100 according to the present embodiment. The control device 100 includes a control amount computation unit 110, a definition switching unit 120, and a mode determination unit 130 as functional blocks. These functional blocks are achieved by the processor 101 of the control device 100 executing a control program stored in the memory 102.

The control amount computation unit 110 calculates the control amount CON for the vehicle travel control based on the detected parameter SEN and the driving environment information ENV. More specifically, the control amount computation unit 110 calculates the calculated control amount CON-A based on the input value SEN-B of the detected parameter SEN. There is no need to switch the computation processing in the control amount computation unit 110 between in the first mode and in the second mode. Therefore, the computation load on the control amount computation unit 110 is reduced and the computation time is reduced.

The definition switching unit 120 holds definition information DEF. The definition information DEF defines the correspondence relationship between the detected value SEN-A and the input value SEN-B and the correspondence relationship between the calculated control amount CON-A and the instruction control amount CON-B (see FIGS. 5 to 7). Such the definition information DEF is beforehand generated and stored in the memory 102 of the control device 100.

The definition switching unit 120 receives the detected value SEN-A from the travel state sensor 20. The definition switching unit 120 refers to the definition information DEF to acquire the input value SEN-B associated with the detected value SEN-A. In other words, the definition switching unit 120 converts the detected value SEN-A into the input value SEN-B. Then, the definition switching unit 120 outputs the input value SEN-B to the control amount computation unit 110.

Moreover, the definition switching unit 120 receives the calculated control amount CON-A calculated by the control amount computation unit 110. The definition switching unit 120 refers to the definition information DEF to acquire the instruction control amount CON-B associated with the calculated control amount CON-A. In other words, the definition switching unit 120 converts the calculated control amount CON-A into the instruction control amount CON-B. Then, the control device 100 controls the travel device 50 in accordance with the instruction control amount CON-B.

Furthermore, the definition information DEF includes first definition information DEF1 for the first mode and second definition information DEF2 for the second mode. As described in FIGS. 5 to 7, the definition by the first definition information DEF1 and the definition by the second definition information DEF2 are different from each other. In the first mode, the definition switching unit 120 uses the first definition information DEF1 as the definition information DEF. In the second mode, on the other hand, the definition switching unit 120 uses the second definition information DEF2 as the definition information DEF. That is, the definition switching unit 120 executes switching processing that switches the definition information DEF according to the mode.

The mode determination unit 130 determines the mode of the vehicle travel control. For example, the mode determination unit 130 determines a desired movement direction as the forward direction based on the driving environment information ENV. When the determined forward direction is the first direction D1, the mode determination unit 130 selects the first mode. On the other hand, when the determined forward direction is the second direction D2, the mode determination unit 130 selects the second mode. That is, the mode determination unit 130 executes switching processing that switches the mode of the vehicle travel control between the first mode and the second mode.

The mode determination unit 130 notifies the definition switching unit 120 of the selected mode. The definition switching unit 120 uses the definition information DEF associated with the selected mode. When the forward direction is changed, the mode determination unit 130 switches the selected mode and the definition switching unit 120 switches the definition information DEF used. It can also be said that the switching of the mode of the vehicle travel control is the switching of the definition information DEF.

As described above, the control device 100 according to the present embodiment holds the first definition information DEF1 and the second definition information DEF2. In the first mode, the control device 100 executes the vehicle travel control in accordance with the first definition information DEF1. In the second mode, on the other hand, the control device 100 executes the vehicle travel control in accordance with the second definition information DEF2. As a result, it is possible to appropriately execute the vehicle travel control.

1-5. Modification Examples

In the above description, the definitions of both of the detected parameter SEN and the control amount CON are switched. However, the present embodiment is not limited to that.

In a case of a vehicle configuration where there is no need to switch the definition of the control amount CON, only the definition of the detected parameter SEN is switched. In that case, the definition information DEF defines the correspondence relationship between the detected value SEN-A and the input value SEN-B. The calculated control amount CON-A calculated by the control device 100 is used as the instruction control amount CON-B as it is.

In a case of a vehicle configuration where there is no need to switch the definition of the detected parameter SEN, only the definition of the control amount CON is switched. In that case, the definition information DEF defines the correspondence relationship between the calculated control amount CON-A and the instruction control amount CON-B. The detected value SEN-A of the detected parameter SEN is used as the input value SEN-B as it is.

I-6. Summary

According to the present embodiment, the control device 100 of the automated driving system 10 executes the vehicle travel control. In the vehicle travel control, the control device 100 calculates the control amount CON based on the detected parameter SEN and controls the travel device 50 in accordance with the control amount CON.

Modes of the vehicle travel control include the first mode and the second mode. In the first mode, the control device 100 executes the vehicle travel control by setting the first direction D1 from the second wheel 5-2 toward the first wheel 5-1 as the forward direction. In the second mode, on the other hand, the control device 100 executes the vehicle travel control by setting the second direction D2 from the first wheel 5-1 toward the second wheel 5-2 as the forward direction. That is, according to the present embodiment, the forward direction and the backward direction are not fixed but flexibly switchable.

In order to appropriately execute the vehicle travel control, it is necessary to switch the definition of the detected parameter SEN or the control amount CON along with the switching of the mode (i.e., the switching of the forward direction and the backward direction). For that purpose, the control device 100 holds the definition information DEF that defines the detected parameter SEN or the control amount CON. The definition information DEF includes the first definition information DEF1 for the first mode and the second definition information DEF2 for the second mode. In the first mode, the control device 100 executes the vehicle travel control in accordance with the first definition information DEF1. In the second mode, on the other hand, the control device 100 executes the vehicle travel control in accordance with the second definition information DEF2. As a result, it is possible to flexibly switch the forward direction and the backward direction and to appropriately execute the vehicle travel control.

According to the present embodiment, since the forward direction is flexibly switchable, there is a case where it is possible to efficiently move the vehicle 1. For example, as described in FIG. 4, flexibly switching the forward direction makes it unnecessary to turn around the vehicle 1 when moving from the point B to the point C.

Moreover, the control device 100 may execute the vehicle travel control such that the vehicle 1 always moves forward in the forward direction without moving backward. As a result, processing required for the vehicle travel control is simplified.

The technique according to the present embodiment can also be applied to MaaS (Mobility as a Service) and the like, for example.

### 2. Second Embodiment

As described above, the control device 100 executes the “switching processing” that switches the mode of the vehicle travel control between the first mode and the second mode. If the switching processing is executed during a period when a behavior of the vehicle 1 is large, the behavior of the vehicle 1 may become an unintended one. Similarly, if the switching processing is executed during a period when control (operation) of the vehicle 1 is strong, the control of the vehicle 1 may become an unintended one. These are not desirable from a viewpoint of stable vehicle travel control. Moreover, an occupant of the vehicle 1 feels a sense of strangeness to the unintended behavior and control of the vehicle 1. In view of the above, according to a second embodiment, the control device 100 permits or prohibits the switching processing depending on a situation.

For example, a “vehicle behavior amount” representing a magnitude of the behavior of the vehicle 1 is considered. The vehicle behavior amount is exemplified by a longitudinal velocity, a longitudinal acceleration, a lateral acceleration, a vertical acceleration, a yaw rate, a pitch rate, a roll rate, and so forth. A switching permission condition is that the vehicle behavior amount is within an allowable range. In other words, the switching permission condition is that the vehicle behavior amount is equal to or less than a threshold value. The control device 100 can determine, based on the detected parameter SEN, whether or not the switching permission condition is satisfied.

As another example, a “vehicle control amount” representing a magnitude of the control of the vehicle 1 is considered. The vehicle control amount is exemplified by a front wheel steering angle, a front wheel steering angular velocity, a front wheel steering angular acceleration, a rear wheel steering angle, a rear wheel steering angular velocity, a rear wheel steering angular acceleration, the driving force, the braking force, and so forth. The switching permission condition is that the vehicle control amount is within an allowable range. In other words, the switching permission condition is that the vehicle control amount is equal to or less than a threshold value. The control device 100 can determine, based on the control amount CON, whether or not the switching permission condition is satisfied.

The switching permission condition may be that the vehicle behavior amount and the vehicle control amount are equal to or less than the threshold values, respectively. The control device 100 can determine, based on the detected parameter SEN and the control amount CON, whether or not the switching permission condition is satisfied.

When the switching permission condition is not satisfied, the control device 100 prohibits the switching processing. On the other hand, when the switching permission condition is satisfied, the control device 100 permits the switching processing. After the switching processing is permitted, the control device 100 executes the switching processing.

According to the second embodiment, the switching processing is prevented from being executed during a period when the vehicle behavior amount or the vehicle control amount is large. Therefore, the behavior or the control of the vehicle 1 is prevented from becoming an unintended one. As a result, stability of the vehicle travel control is secured. Moreover, the sense of strangeness to the vehicle travel control is suppressed.

### 3. Third Embodiment

According to a third embodiment, the control device 100 maintains a state in which the switching permission condition is satisfied for a first period after starting the switching processing. For example, the control device 100 controls the braking device 53 to maintain for the first period a state in which the vehicle 1 is stopped. The first period may be a fixed period or may be a variable period. The control to maintain for the first period the state in which the switching permission condition is satisfied is hereinafter referred to as “state maintenance control”.

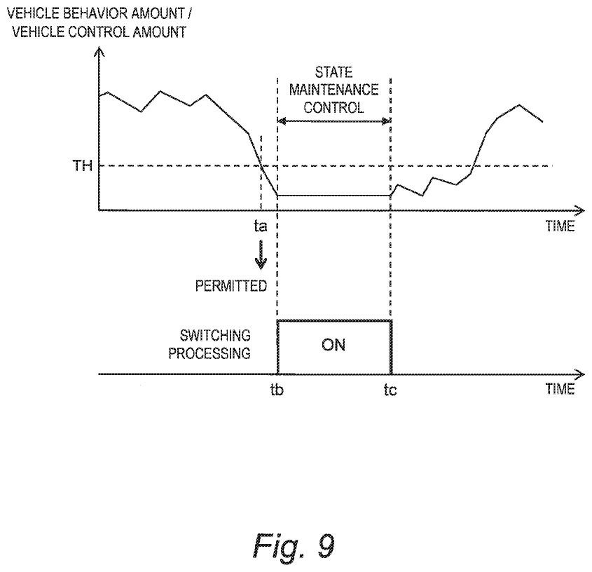

FIG. 9 is a timing chart for explaining the state maintenance control. A horizontal axis represents a time, and a vertical axis represents the vehicle behavior amount or the vehicle control amount. At a time ta, the vehicle behavior amount or the vehicle control amount becomes below the threshold value TH. As a result, the switching permission condition is satisfied. After that, the switching processing is executed for a period from a time tb to a time tc. During the period from the time tb to the time tc, the control device 100 executes the state maintenance control to maintain the state in which the switching permission condition is satisfied. As a result, it is possible to reliably execute the switching processing.

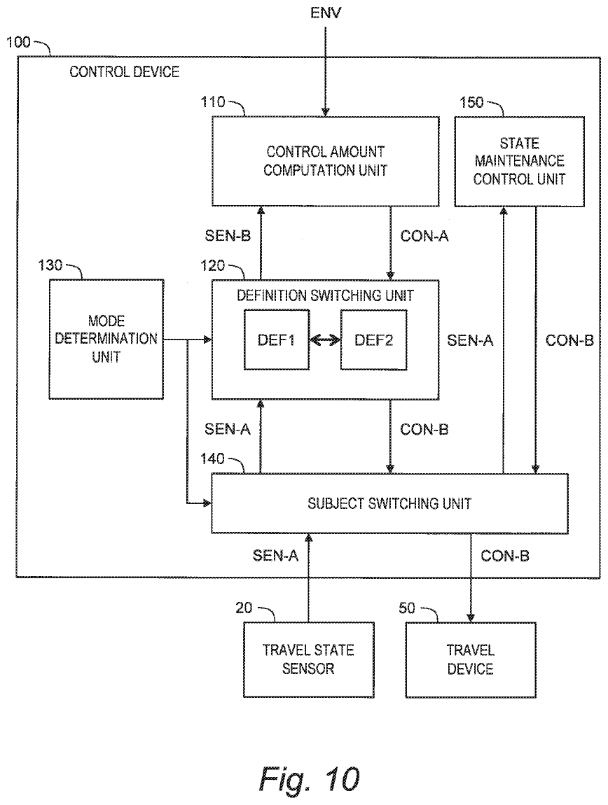

FIG. 10 is a block diagram showing a functional configuration example of the control device 100 according to the present embodiment. The control device 100 further includes a subject switching unit 140 and a state maintenance control unit 150.

The subject switching unit 140 switches a subject that calculates the control amount CON. Usually, the subject switching unit 140 selects the control amount computation unit 110 as the subject that calculates the control amount CON. The subject switching unit 140 acquires information on the mode switching from the mode determination unit 130. Over the first period after the start of the switching processing, the subject switching unit 140 selects the state maintenance control unit 150 as the subject that calculates the control amount CON.

The state maintenance control unit 150 calculates the instruction control amount CON—B based on the detected value SEN-A of the detected parameter SEN. Here, the instruction control amount CON-B is calculated such that the state in which the switching permission condition is satisfied is maintained. For example, the state maintenance control unit 150 calculates the target braking force and the target driving force with which the vehicle 1 continues to stop, as the instruction control amount CON-B. Then, the control device 100 controls the travel device 50 in accordance with the instruction control amount CON-B calculated by the state maintenance control unit 150.

According to the third embodiment, the state in which the switching permission condition is satisfied is maintained after the start of the switching processing. As a result, it is possible to reliably execute the switching processing.

What is claimed is:

1. An automated driving system that controls automated driving of a vehicle,
the vehicle comprising a first wheel and a second wheel that are arranged separately in a longitudinal direction,
a first direction being a direction from the second wheel toward the first wheel,
a second direction being a direction from the first wheel toward the second wheel,
the automated driving system comprising:
a sensor configured to detect a parameter representing a travel state of the vehicle;
a travel device configured to perform steering, acceleration, and deceleration of the vehicle; and
a control device configured to execute vehicle travel control that calculates a control amount based on an input value associated with a detected value of the parameter and controls the travel device in accordance with the control amount, wherein
definition information defines a correspondence relationship between the detected value and the input value,
modes of the vehicle travel control include:
a first mode in which the vehicle travel control is executed by setting the first direction as a forward direction; and
a second mode in which the vehicle travel control is executed by setting the second direction as the forward direction, and
the control device is further configured to:
hold first definition information being the definition information for the first mode and second definition information being the definition information for the second mode;
execute the vehicle travel control in accordance with the first definition information in the first mode; and
execute the vehicle travel control in accordance with the second definition information in the second mode.

2. The automated driving system according to claim 1, wherein
a sign of the detected value varies depending on whether a movement direction of the vehicle is the first direction or the second direction,
in one of the first mode and the second mode, the input value is the detected value, and
in another of the first mode and the second mode, the input value is −1 times the detected value.

3. The automated driving system according to claim 1, wherein
a sign of the detected value varies depending on whether an acceleration direction of the vehicle is a third direction or a fourth direction opposite to the third direction,
in one of the first mode and the second mode, the input value is the detected value, and
in another of the first mode and the second mode, the input value is −1 times the detected value.

4. An automated driving system that controls automated driving of a vehicle,
the vehicle comprising a first wheel and a second wheel that are arranged separately in a longitudinal direction,
a first direction being a direction from the second wheel toward the first wheel,
a second direction being a direction from the first wheel toward the second wheel,
the automated driving system comprising:
a sensor configured to detect a parameter representing a travel state of the vehicle;
a travel device configured to perform steering, acceleration, and deceleration of the vehicle; and
a control device configured to execute vehicle travel control that calculates a control amount based on the parameter and controls the travel device in accordance with an instruction control amount associated with the calculated control amount, wherein
definition information defines a correspondence relationship between the calculated control amount and the instruction control amount,
modes of the vehicle travel control include:
a first mode in which the vehicle travel control is executed by setting the first direction as a forward direction; and
a second mode in which the vehicle travel control is executed by setting the second direction as the forward direction, and
the control device is further configured to:
hold first definition information being the definition information for the first mode and second definition information being the definition information for the second mode;
execute the vehicle travel control in accordance with the first definition information in the first mode; and
execute the vehicle travel control in accordance with the second definition information in the second mode.

5. The automated driving system according to claim 4, wherein
the travel device includes a steering device that turns the first wheel and the second wheel independently,
the instruction control amount includes a first steering amount of the first wheel and a second steering amount of the second wheel,
the control device calculates a front wheel steering amount and a rear wheel steering amount as the control amount,
in one of the first mode and the second mode, the first steering amount is the front wheel steering amount and the second steering amount is the rear wheel steering amount, and
in another of the first mode and the second mode, the first steering amount is the rear wheel steering amount and the second steering amount is the front wheel steering amount.

6. The automated driving system according to claim 4, wherein
the travel device includes a driving device that generates a driving force in each of the first direction and the second direction,
the instruction control amount includes an instruction driving force of a drive wheel being one of the first wheel and the second wheel,
the control device calculates a target driving force as the control amount,
in one of the first mode and the second mode, the instruction driving force is the target driving force, and
in another of the first mode and the second mode, the instruction driving force is −1 times the target driving force.

7. The automated driving system according to claim 4, wherein
the travel device includes a driving device that generates a driving force in each of the first direction and the second direction,
the instruction control amount includes a first driving force of the first wheel and a second driving force of the second wheel,
the control device calculates a front wheel driving force and a rear wheel driving force as the control amount,
in one of the first mode and the second mode, the first driving force is the front wheel driving force and the second driving force is the rear wheel driving force, and
in another of the first mode and the second mode, the first driving force is −1 times the rear wheel driving force and the second driving force is −1 times the front wheel driving force.

8. The automated driving system according to claim 4, wherein
the travel device includes a braking device that generates a braking force in each of the first direction and the second direction,
the instruction control amount includes a first braking force of the first wheel and a second braking force of the second wheel,
the control device calculates a front wheel braking force and a rear wheel braking force as the control amount,
in one of the first mode and the second mode, the first braking force is the front wheel braking force and the second braking force is the rear wheel braking force, and
in another of the first mode and the second mode, the first braking force is −1 times the rear wheel braking force and the second braking force is −1 times the front wheel braking force.

9. The automated driving system according to claim 1, wherein
the control device is further configured to execute switching processing that switches the first mode and the second mode,
a switching permission condition includes that at least one of a vehicle behavior amount representing a magnitude of a behavior of the vehicle and a vehicle control amount representing a magnitude of control of the vehicle is equal to or less than a threshold value, and
the control device is further configured to:
determine, based on at least one of the parameter and the control amount, whether or not the switching permission condition is satisfied;
permit the switching processing when the switching permission condition is satisfied; and
prohibit the switching processing when the switching permission condition is not satisfied.

10. The automated driving system according to claim 9, wherein
the control device is further configured to execute state maintenance control that maintains a state in which the switching permission condition is satisfied for a first period after starting the switching processing.

11. The automated driving system according to claim 1, wherein
the control device executes the vehicle travel control such that the vehicle moves forward in the forward direction without moving backward.

12. The automated driving system according to claim 4, wherein
the control device is further configured to execute switching processing that switches the first mode and the second mode,
a switching permission condition includes that at least one of a vehicle behavior amount representing a magnitude of a behavior of the vehicle and a vehicle control amount representing a magnitude of control of the vehicle is equal to or less than a threshold value, and
the control device is further configured to:
determine, based on at least one of the parameter and the control amount, whether or not the switching permission condition is satisfied;
permit the switching processing when the switching permission condition is satisfied; and
prohibit the switching processing when the switching permission condition is not satisfied.

13. The automated driving system according to claim 12, wherein
the control device is further configured to execute state maintenance control that maintains a state in which the switching permission condition is satisfied for a first period after starting the switching processing.

14. The automated driving system according to claim 4, wherein
the control device executes the vehicle travel control such that the vehicle moves forward in the forward direction without moving backward.
